(19) United States
(12) Patent Application Publication
(10) Pub. No.: US 2019/0007455 A1
(43) Pub. Date: Jan. 3, 2019

(54) MANAGEMENT OF A HOSTS FILE BY A CLIENT SECURITY APPLICATION

(71) Applicant: Fortinet, Inc., Sunnyvale, CA (US)

(72) Inventor: Ping Xiao Sheng, Ottawa (CA)

(73) Assignee: Fortinet, Inc., Sunnyvale, CA (US)

(21) Appl. No.: 15/639,293

(22) Filed: Jun. 30, 2017

(51) Int. Cl. H04L 29/06

(52) U.S. Cl. CPC H04L 63/20; H04L 63/126; H04L 63/0272; G06F 21/60; H04L 63/0245; H04L 63/145; H04L 63/02

(57) ABSTRACT

Systems and methods for managing a host name resolution file by a client security manager are provided. In one embodiment, a client security manager acquires a remote host name resolution file maintained by a remote server or a network security appliance and imports the remote host name resolution file into a local host name resolution file of the client computer system. The local host name resolution file is used for resolving host names to internet protocol (IP) addresses on the client computer system.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright 2017, Fortinet, Inc.

### BACKGROUND

### Field

Embodiments of the present invention generally relate to computer networking. In particular, various embodiments relate to management of host name resolution files of client machines.

### Description of the Related Art

Most operating systems include a host name resolution (“hosts”) file that maps hostnames to Internet Protocol (IP) addresses. When a client machine needs to resolve a host name, it may check within the local hosts file first. If the host name is not found within the local hosts file, then the client machine may resolve it through a remote domain name system (DNS) server. As the hosts file is a plain text file and can be edited by a local user, using a customized hosts file is an effective way to block accesses to restricted hosts that might perform undesired activities, such as deliver advertisements, banners, 3rd party cookies and page counters, web bugs, and some hijackers. Various customized hosts files with a large number of entries are readily available from many sources. However, it is not easy for an ordinary user to make and utilize a customized hosts file. The hosts file may be stored at different locations in different operating systems, even in different versions of the same operating system. For example, the hosts file is located at “% WinDir %\hosts” for Microsoft Windows 95/98, and located at “% SystemRoot %\System32\drivers\etc\hosts” for later versions. For other operating systems, such as Mac OS, Linux, Android, iOS, the hosts files is located in different folders. The hosts file contains lines of text consisting of an IP address in the first text field followed by one or more host names. Each field is separated by a space or tab character. When a user edits the hosts file, the above format should be followed without any error. The hosts file should also be encoded in correct encoding formats without any illegal characters. A simple syntax error can renders the whole file useless.

Using a customized hosts file as a tool to protect a client machine demands user skills and knowledge about host name resolution and operating systems. Further, as the hosts file solution is implemented by the local machine, it is impractical for network administrators to manually manage the numerous hosts files distributed among the client computers within a private network. Therefore, there is a need for managing local hosts files of client machines in a centralized way to ensure that the hosts files are correctly configured for protecting the client machines.

### SUMMARY

Systems and methods are described for managing a host name resolution file by a client security manager. In one embodiment, a client security manager acquires a remote host name resolution file maintained by a remote server or a network security appliance and imports the remote host name resolution file into a local host name resolution file of the client computer system. The local host name resolution file is used for resolving host names to internet protocol (IP) addresses on the client computer system.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates exemplary process units of a client security manager and a file server in accordance with a first embodiment of the present invention;

FIG. 2 illustrates exemplary process units of a client security manager and a network security appliance in accordance with a second embodiment of the present invention;

FIG. 3 is a flow diagram illustrating a process for automatically importing a hosts file by a client security manager in accordance with an embodiment of the present invention; and

FIG. 4 is a flow diagram illustrating a process for automatically importing a hosts file by a client security manager in accordance with another embodiment of the present invention;

FIG. 5 is a flow diagram illustrating a process for maintaining a hosts file by a network security appliance and managing local hosts files of client machines from the network security appliance in accordance with an embodiment of the present invention; and

FIG. 6 illustrates an exemplary computer system in which or with which embodiments of the present invention may be utilized.

### DETAILED DESCRIPTION

Systems and methods for managing a host name resolution file by a client security manager are provided. In one embodiment, a client security manager acquires a remote host name resolution file maintained by a remote server and imports the remote host name resolution file into a local host name resolution file of the client computer system. The local host name resolution file is used for resolving host names to internet protocol (IP) addresses on behalf of the client computer system.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The phrase “network security appliance” generally refers to a hardware device or appliance configured to be coupled to a network and to provide one or more of data privacy, protection, encryption and security. The network security appliance can be a device providing one or more of the following features: network firewalling, VPN, antivirus, intrusion prevention (IPS), content filtering, data leak prevention (DLP), antispam, antispyware, logging, reputation-based protections, event correlation, network access control, vulnerability management, load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

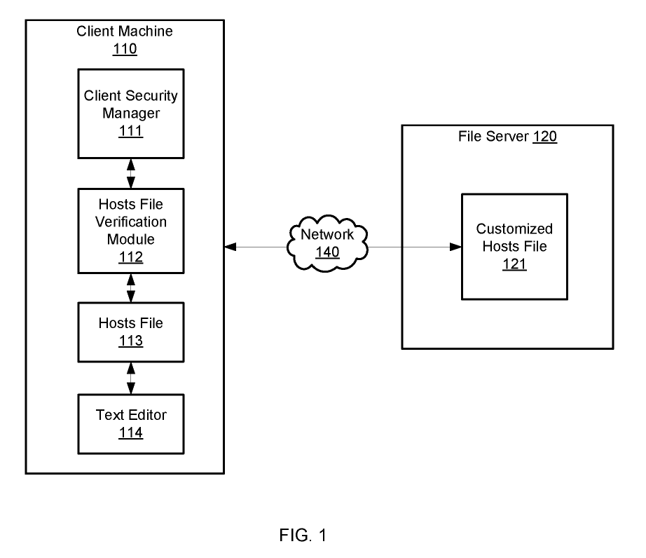

FIG. 1 illustrates exemplary process units of a client security manager 110 and a file server 120 in accordance with an embodiment of the present invention. In the example of FIG. 1, file server 120 may be a file transfer protocol (FTP) server or a web server with shared files that can be accessed by client machines via a network 140, such as a local area network (LAN), a wide area network (WAN) or the Internet. A customized hosts file 121 may include host name-IP address mappings that are tailored to enhance network security or regulate network accessibility of a client machine. For example, if a user wants to block some restricted categories of websites, such as gambling, advertisement or social networking, restricted host names of these categories may be mapped to a non-routable IP address, for example 0.0.0.0, in the hosts file. When the client machine tries to access a restricted host by its host name, the access is blocked because the host name is resolved to a non-routable IP address. File server 120 may maintain customized hosts file 121 and provide it to its subscribers or the public. Below is an example of a customized hosts file that can be used to block access to advertisement/gambling/porn websites in which lines beginning with the ‘#’ character are comments

# Each entry should be kept on an individual line.
# The IP # address should be placed in the first column
# followed by the corresponding host name.
# The IP address and the host name should be separated by
# at least one space.
#
# Additionally, comments (such as these) may be inserted
# on individual lines or following the machine name denoted
# by a ‘#’symbol.
127.0.0.1 localhost
127.0.0.1 localhost.localdomain
127.0.0.1 local
255.255.255.255 broadcasthost
::1 localhost
# [Advertisement]
0.0.0.0 advertisiement_site_a.com
0.0.0.0 advertisiement_site_b.com
# [gambling]
0.0.0.0 gamble_site_a.com
0.0.0.0 gamble_site_b.com
# [porn]
0.0.0.0 porn_site_a.com
0.0.0.0 porn_site_b.com
# [social]
0.0.0.0 social_site_a.com
0.0.0.0 social_site_b.com

Client machine 110 may be any computing device with an operating system that supports name resolution by a hosts file. Client machine 110 may be a personal computer, a laptop or a hand-held device and the operating system may be Microsoft Windows, MacOS, Linux, Unix, iOS or Android. Client machine 110 may include a client security manager 111, a hosts file verification module 112, a hosts file 113 and a text editor 114.

Client security manager 111 may be a software application (e.g., an endpoint security program) that can be installed and run on client machine 110 to enhance its security. Client security manager 111, for example the FortiClient endpoint security solution available from the assignee of the present invention, may perform security tasks, such as virus/malware scanning, intrusion prevention, data leak prevention, network traffic regulation, logging, and system configuration.

In the present example, client security manager 111 may download customized hosts file 121 from file server 120 and import it to a local hosts file 113 or replace the local hosts file 113 with the downloaded customized hosts file 121. After the downloaded customized hosts file 121 is imported to the local hosts file, the network accessibility of client machine 110 may be regulated based on the download customized hosts file 121.

Further, if customized hosts file 121 is downloaded from a 3rd party file server, it may contain errors that may cause the operating system to ignore the hosts file if it is imported directly to client machine 110. When hosts file 113 is edited by a user at client machine 110 through text editor 114, errors may be introduced by the user. Hosts file verification module 112 is used for verifying the integrity of hosts file 113 or the downloaded customized hosts file 121. Hosts file verification module 112 may check the syntax, file name, and encoding of the hosts file to ensure it is in compliance with the requirements of the operating system. Hosts file verification module 112 may verify that the file name of the downloaded hosts file is correct, for example the file name is “hosts” for most operating systems. The hosts file verification module 112 may determine whether the hosts file is encoded in American National Standards Institute (ANSI) format or UTF-8 and does not contain any illegal characters. Hosts file verification module 112 may also read each line of the hosts file to make sure it contain a legitimate IP address and host name(s) separated by a space or tab character(s). When an error is found in the hosts file, hosts file verification module 112 may try to correct it or show a warning message to the user of client machine 110.

Further, some operating systems support name service switches that allow users to change the priorities of multiple name resolution methods that are used by the operating systems. For example, the order of name resolution may be configured through a configuration file “nsswitch.conf” in the Linux operating system. Client security manager 111 may change the name service switch to ensure that the local hosts file has higher priority over remote DNS.

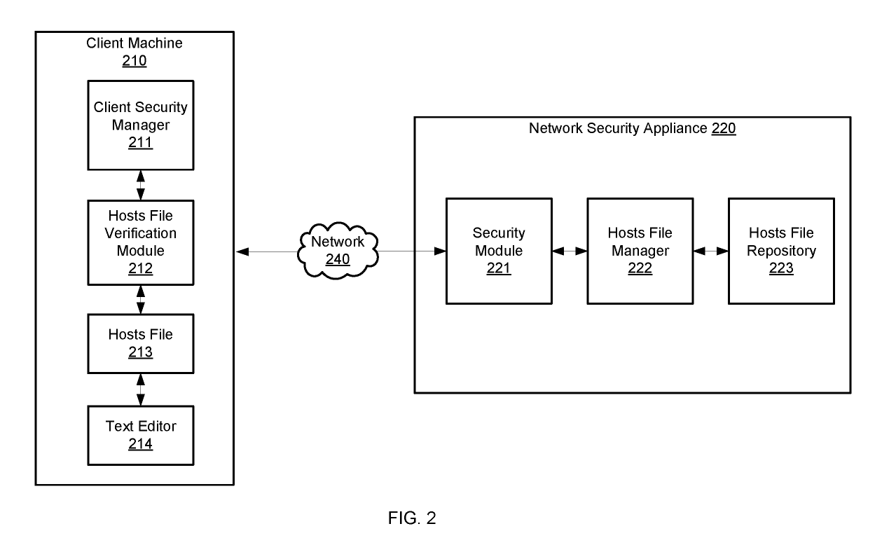

FIG. 2 illustrates exemplary process units of a client security manager 210 and a network security appliance 220 in accordance with an embodiment of the present invention. In the example of FIG. 2, network security appliance 220 may be a firewall, for example, a FortiGate next generation firewall (NGFW) available from the assignee of the present invention, deployed at the border of a private network (e.g., an enterprise network) to protect it from attacks or intrusions. In another example, network security appliance 220 may be a cloud-based network security service, for example, the FortiGuard network security solution or the FortiCloud cloud-based management platform available from the assignee of the present invention. Network security appliance 220 may comprise a security module 221, a hosts file manager 222 and a hosts file repository 223.

Security module 221 may be used for intercepting network traffic going through the network and determining whether the network traffic is allowable based on security policies implemented by security module 221. Other security functions may also be executed by security module 221, for example, virus scanning, data leak prevention and deep inspection, which are beyond the scope of the present disclosure.

Hosts file manager 222 is used for maintaining customized hosts files that can be used by users of a private network or subscribers. For example, the administrator of the private network may edit a hosts file manually through a text editor. Host file manager 222 may check the integrity of the updated hosts file when the hosts file is edited. In another example, hosts file manager 222 may generate a hosts file automatically based on a Uniform Resource Locator (URL) white list, a URL black list, a URL category list and/or a URL reputation list. For example, hosts file manager 222 may go through the URL white list, black list, category list and/or reputation list to determine whether domain names of the URLs specified therein should be blocked. When a domain name is in the black list or a restricted category, or has a bad reputation, hosts file manager 222 may map the domain name to a non-routable IP address in the hosts file. In a further example, hosts file manager 222 may further generate multiple hosts files based on network security policies. For example, multiple hosts files may be generated and maintained based on workgroups, levels, ages, locations or other environment information of users of the private network. The hosts files may be stored within hosts file repository 223. When a user requests a hosts file, a hosts file that is suitable for the user may be retrieved from hosts file repository 223 and sent or pushed back to the user by host file manager 222.

In the present example, client machine 210 includes a client security manager 211, a hosts file verification module 212, a hosts file 213 and a text editor 214.

Client security manager 211 is similar to client security manager 111 of FIG. 1 except that client security manager 211 may be managed by network security appliance 220. Client security manager 211 may retrieve virus signatures or network or security settings from the network security appliance 220 and implement security settings for client machine 210. In the present example, client security manager 211 may register with network security appliance 220 when client machine 210 is connected to a private network that is managed by network security appliance 220. Client security manager 211 may collect user information and environment information of client machine 210 and send it to network security appliance 220. After client security manager 211 has registered with network security appliance 220, a customized hosts file that corresponds to client machine 210 may be downloaded by client security manager 211 or pushed back from network security appliance 220. Client security manager 211 then imports the downloaded customized hosts file into local hosts file 213 or replaces local hosts file 213 with the downloaded customized hosts file.

The functions of hosts file verification module 212, hosts file 213 and text editor 214 may be the same as their counterparts described with reference to FIG. 1.

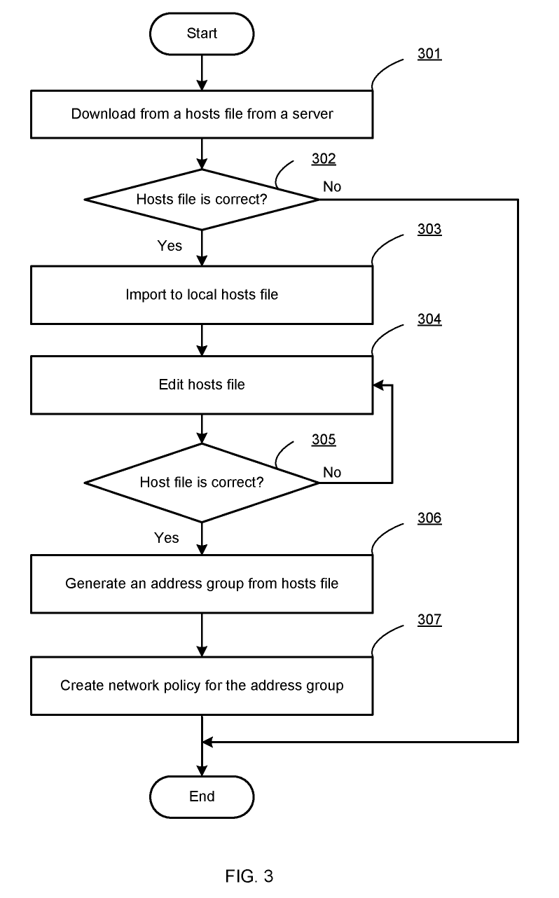

FIG. 3 is a flow diagram illustrating a process for automatically importing a hosts file by a client security manager in accordance with an embodiment of the present invention.

At block 301, a client security manager running on a client machine may download a hosts file from a server, for example, a web server or an FTP server. The hosts file may be a customized hosts file for use in connection with blocking or controlling a client machine's ability to access to local or remote hosts. Those skilled in the art will appreciate the server from which the customized hosts file is downloaded may be a public or a private server and the customized hosts file may be tailored for private users/subscribers or public users.

At block 302, the client security manager may check the downloaded hosts file to determine whether it contains syntax errors or other formatting errors. As a customized hosts file may contain thousands of entries, a syntax error or format error may be inadvertently introduced when the author edits the file. The client security manager may also verify that the IP address and the host name of each entry within the customized hosts file are in the proper format and that the IP address field and corresponding host name field are separated appropriately, e.g., by a space or a tab character. The client security manager may further verify that the hosts file is encoded with correct character encoding and no illegal characters are contained in the file. In one embodiment, the client security manager corrects syntax and/or format errors discovered during verification of the downloaded customized hosts file. If the downloaded customized hosts file contains errors that cannot be corrected by the client security manager, it may be abandoned.

At block 303, the client security manager imports the downloaded customized hosts file to local hosts file. In one example, the client security manager may merge the downloaded customized hosts file with the existing local hosts file. In another example, the client security manager may replace the local hosts file with the downloaded customized hosts file in order that the name resolution is controlled by the downloaded hosts file.

Optionally, if the operating system of the client machine supports name service switch, the client security manager may change the switch in order that the local hosts file has higher priority that remote DNS in order to ensure the local hosts file is searched for a host name before resorting to use of remote DNS.

Optionally, the client security manager may flush a local DNS cache in order that the imported hosts file may take effect immediately.

At block 304, the local hosts file is changed, for example, it is edited by the user of the client machine.

At block 305, the client security manager may check the integrity of the hosts file. If an error is found, e.g., a syntax or formatting error, the client security manager may try to correct the error. If the error cannot be corrected, the client security manager may present a warning message to the user.

At block 306, the client security manager may optionally create an address group for the IP addresses contained within the hosts file.

At block 307, the client security manager may create a security policy for the address group (those IP addresses specified within the hosts file). For example, the client security manager may create a policy for the address group that logs any access to hosts of the address group. In another example, the client security manager may create a policy for the address group that redirects accesses to hosts of the address group to a black hole IP address or a network security appliance in order that such accesses may be blocked or checked.

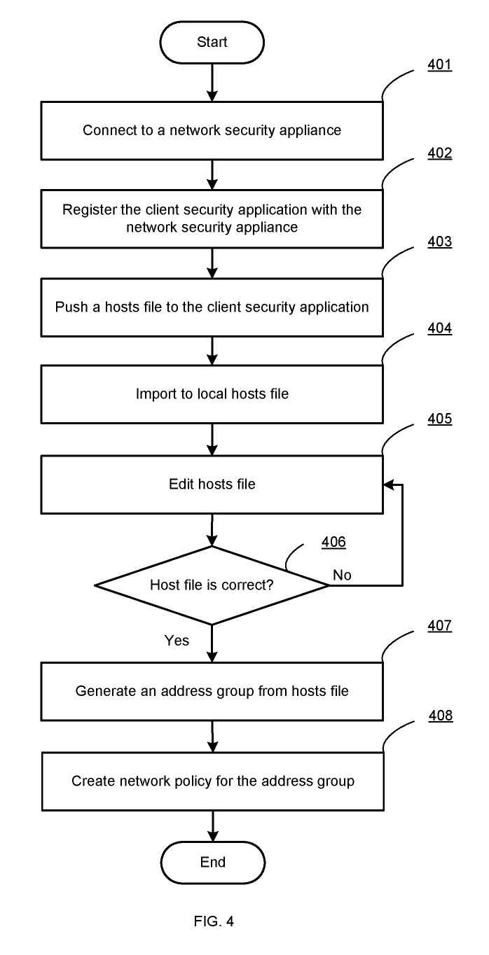

FIG. 4 is a flow diagram illustrating a process for automatically importing a hosts file by a client security manager in accordance with an embodiment of the present invention.

At block 401, a client security manager of a client machine connects to a network security appliance through a network. The client security manager is running on the client machine for managing security of the client machine and the network security appliance is used for managing security of traffic passing through the network. In one embodiment, the client machine is within a private network that is protected by the network security appliance. In another embodiment, the client machine connects to the network security appliance or a cloud-based network security service through a public network, for example, the Internet.

At block 402, the client security manager may register with the network security appliance and may be managed by the network security appliance. For example, the network security appliance may push updated antivirus signatures to the client security manager in order that the client security manager may scan the client machine or network traffic directed to and/or originating from the client machine using the antivirus signatures. The network security appliance may also push other configuration information, for example, Certificate Authority (CA) certificates and other network security settings, to the client security manager in order that the client security manager may configure the client machine to comply with security policies of the private network.

The client machine may also collect local environment information of the client machine, for example, operating system information, hardware and software configurations, location information and user information, and send the environment information to the network security appliance in order that the network security appliance may provide corresponding managements.

At block 403, the network security appliance may push a hosts file to the client security manager or the client security manager may retrieve the hosts file from the network security appliance or a file server designated by the network security appliance. Optionally, the network security appliance may maintain different hosts files to be used for different types or groups of users as noted above and/or based on various environment information gathered regarding the client machine. The network security appliance may find a hosts file based on the environment information of the client machine and push the hosts file the client security manager. For example, if the client machine is within the private network, a hosts file that blocks social networking may be pushed to the client security manager. If the client machine is outside the private network, a hosts file that allows social networking may be pushed to the client security manager.

At block 404, the client security manager imports the retrieved hosts file to the local hosts file or replaces the local hosts file with the retrieved hosts file. By using the hosts file retrieved from the network security appliance, attempts to access the restricted hosts defined by the network security appliance are blocked at the client machine. When accesses to the restricted hosts are blocked at client machines of a private network, the network security appliance need not be involved, thereby alleviating the burden of having to process such blocked requests by the network security appliance of the private network.

The operations of blocks 405-408 may be similar to blocks 304-307 described with reference to FIG. 3. As such, further description of blocks 405-408 are omitted for brevity.

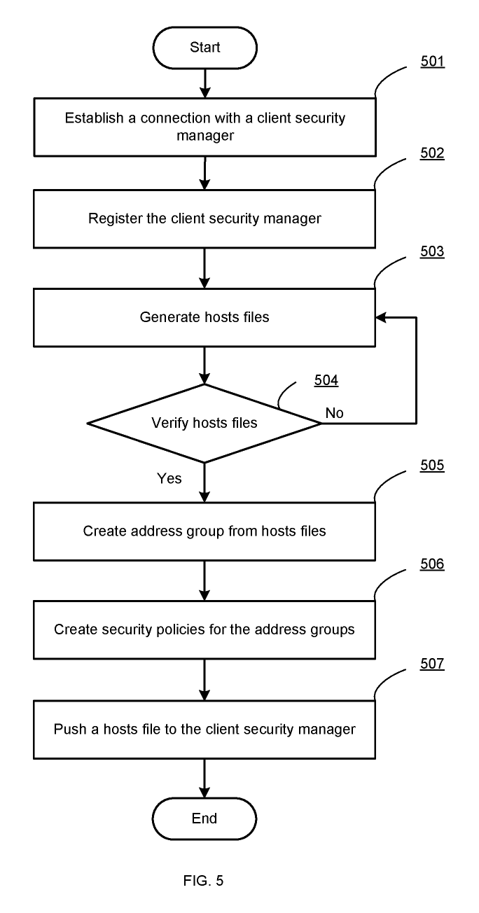

FIG. 5 is a flow diagram illustrating a process for maintaining a hosts file by a network security appliance and managing local hosts files of client machines from the network security appliance in accordance with an embodiment of the present invention.

At block 501, a client security manager of a client machine connects to a network security appliance through a network, which can be a private network or a public network.

At block 502, a network security appliance receives a registration request from a client security manager of the client machine. The network security appliance may also collect environment information associated with the client machine when the client security manager registers with the network security appliance.

At block 503, the network security appliance generates one or more hosts files. In one example, a hosts file may be edited manually by a network administrator. The administrator may map restricted hosts to a non-routable IP address in the hosts file in order that attempted accesses to the restricted hosts may be blocked at the client machine. In another example, a hosts file may be generated automatically based on the firewall policies of the network. In a further example, different hosts files may be generated for different users, for example, based on environment information of their respective client machines and security policies of the network. In a further example, the hosts file may be retrieved from a cloud-based network security service or a third party.

At block 504, the network security appliance may check the integrity of the hosts files for errors when they are manually edited or when they are received from a third party. If there are any errors in the hosts files, the network security appliance may try to correct the errors or may present a warning message to the administrator of the network. The process may go back to block 503 to allow further editing of the hosts files.

At block 505, if the hosts files are correct, the network security appliance may create address groups based on IP addresses or host names appearing within the hosts files.

At block 506, the network security appliance may create security policies for the address groups. For example, a security policy may allow, block or log network traffic from/to hosts in the address groups. Other operations, such as DLP, deep packet inspection or malware scanning, may be implemented on network traffic directed to and/or originated by the hosts in the address group.

At block 507, the network security appliance pushes a hosts file to the client security manager for importing to a local hosts file of the client machine. In one embodiment, network security appliance may select a hosts file from multiple hosts files in accordance with one or more of environment information of the client machine and attributes associated with the user at issue and send it to the client security manager.

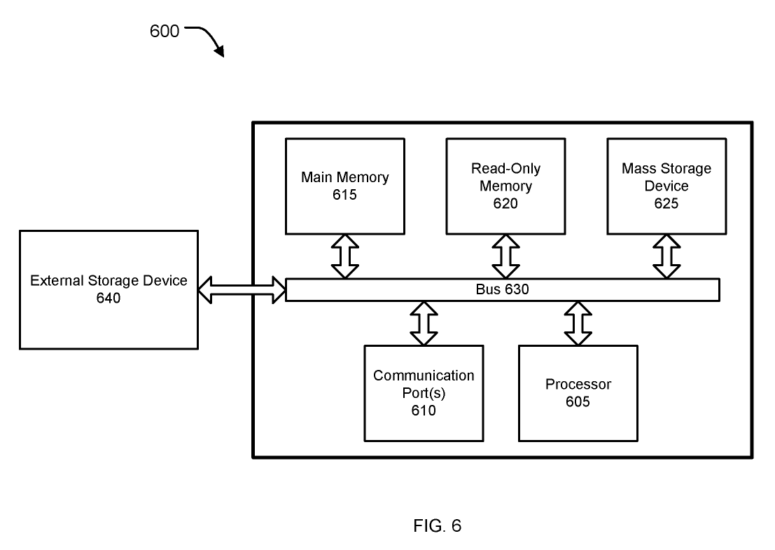

FIG. 6 is an example of a computer system 600 with which embodiments of the present disclosure may be utilized. Computer system 600 may represent or form a part of a network appliance (e.g., network security appliance 220), a server (e.g., file server 120) or a client workstation (e.g., client machine 110 or 210).

Embodiments of the present disclosure include various steps, which have been described in detail above. A variety of these steps may be performed by hardware components or may be embodied on a non-transitory computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 600 includes a bus 630, a processor 605, communication port 610, a main memory 615, a removable storage media 640, a read only memory 620 and a mass storage 625. A person skilled in the art will appreciate that computer system 600 may include more than one processor and communication ports.

Examples of processor 605 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 605 may include various modules associated with embodiments of the present invention.

Communication port 610 can be any of an RS-232 port for use with a modem based dialup connection, a 10/100 Ethernet port, a Gigabit or 10 Gigabit port using copper or fiber, a serial port, a parallel port, or other existing or future ports. Communication port 610 may be chosen depending on a network, such a Local Area Network (LAN), Wide Area Network (WAN), or any network to which computer system 600 connects.

Memory 615 can be Random Access Memory (RAM), or any other dynamic storage device commonly known in the art. Read only memory 620 can be any static storage device(s) such as, but not limited to, a Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication port 610.

Removable storage media 640 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
acquiring, by a client security manager running on a client computer system associated with a private network, a remote host name resolution file maintained by a remote server or a network security appliance associated with the private network;
importing, by the client security manager, the remote host name resolution file into a local host name resolution file of the client computer system; and
using, by the client computer system, the local host name resolution file to resolve host names to Internet Protocol (IP) addresses.

2. The method of claim 1, wherein the remote server comprises a file server and wherein the remote host name resolution file is shared freely or on a subscription basis.

3. The method of claim 2, further comprising prior to said importing, verifying, by the client security manager, integrity of the host name resolution file.

4. The method of claim 1, wherein the network security appliance provides one or more of network firewalling, Virtual Private Networking (VPN), antivirus protection, intrusion prevention (IPS), content filtering, data leak prevention (DLP), antispam, antispyware, logging and reputation-based protections on behalf of the private network.

5. The method of claim 4, further comprising:
establishing, by the client security manager, a connection with the network security appliance through the private network;
sending, by the client security manager, environment information of the client computer system to the network security appliance; and
wherein said acquiring, by a client security manager running on a client computer system associated with a private network, a remote host name resolution file involves the network security appliance selecting among a plurality of remote host name resolution files based on the environment information.

6. The method of claim 4, wherein the remote host name resolution file is pushed to the client security manager by the network security appliance.

7. The method of claim 1, further comprising responsive to editing of the local host name resolution file, verifying, by the client security manager, integrity of the local host name resolution file by checking for one or more of proper syntax, naming of the local host name resolution file and encoding of content of the local host name resolution file.

8. The method of claim 1, further comprising causing, by the client security manager, the local host name resolution file to have higher priority than other remote name resolution methods by appropriately setting a name service switch of the client computer system.

9. The method of claim 1, further comprising:
generating, by the client security manager, an address group from the local host name resolution file;
creating, by the client security manager, a network policy for the address group.

10. A client computer system associated with a private network, the client computer system comprising:
a non-transitory storage device having embodied therein one or more routines representing a client security manager; and
one or more processors coupled to the non-transitory storage device and operable to execute the client security manager to perform a method comprising:
acquiring a remote host name resolution file maintained by a remote server or a network security appliance associated with the private network;
importing the remote host name resolution file into a local host name resolution file of the client computer system, wherein the client computer system uses the local host name resolution file to resolve host names to Internet Protocol (IP) addresses.

11. The client computer system of claim 10, wherein the remote server comprises a file server and wherein the remote host name resolution file is shared freely or on a subscription basis.

12. The client computer system of claim 11, wherein the method further comprises prior to said importing, verifying integrity of the host name resolution file.

13. The client computer system of claim 10, wherein the network security appliance provides one or more of network firewalling, Virtual Private Networking (VPN), antivirus protection, intrusion prevention (IPS), content filtering, data leak prevention (DLP), antispam, antispyware, logging and reputation-based protections on behalf of the private network.

14. The client computer system of claim 13, wherein the method further comprises:
establishing a connection with the network security appliance through the private network;
sending environment information of the client computer system to the network security appliance; and
wherein said acquiring a remote host name resolution file involves the network security appliance selecting among a plurality of remote host name resolution files based on the environment information.

15. The client computer system of claim 13, wherein the remote host name resolution file is pushed to the client security manager by the network security appliance.

16. The client computer system of claim 10, wherein the method further comprises responsive to editing of the local host name resolution file, verifying integrity of the local host name resolution file by checking for one or more of proper syntax, naming of the local host name resolution file and encoding of content of the local host name resolution file.

17. The client computer system of claim 10, wherein the method further comprises causing the local host name resolution file to have higher priority than other remote name resolution methods by appropriately setting a name service switch of the client computer system.

18. The client computer system of claim 1, wherein the method further comprises:
generating an address group from the local host name resolution file;
creating a network policy for the address group.
